(19) United States
(12) Patent Application Publication
(10) Pub. No.: US 2016/0261169 A1
(43) Pub. Date: Sep. 8, 2016

(54) Motor Rotor Cooling System

(71) Applicant: ATIEVA, INC., Menlo Park, CA (US)

(72) Inventor: Peter Dore Rawlinson, Worcestershire (GB)

(73) Assignee: ATIEVA, INC., Menlo Park, CA (US)

(21) Appl. No.: 14/641,335

(22) Filed: Mar. 7, 2015

(51) Int. Cl. H02K 9/00; H02K 9/193; H02K 9/04; H02K 1/32

(52) U.S. Cl. CPC H02K 9/005; H02K 1/32; H02K 9/193; H02K 9/04

(57) ABSTRACT

A rotor assembly for an electric motor is provided that includes coolant passageways that pass through the rotor's lamination stack, thereby providing means for directly cooling the rotor assembly. In order to promote cooling, the coolant passageways within the lamination stack may be shaped, for example in a helical or spiral pattern.

### FIELD OF THE INVENTION

The present invention relates generally to an electric motor assembly and, more particularly, to an efficient motor cooling system that can be used to cool the rotor of a motor assembly.

### BACKGROUND OF THE INVENTION

In response to the demands of consumers who are driven both by ever-escalating fuel prices and the dire consequences of global warming, the automobile industry is slowly starting to embrace the need for ultra-low emission, high efficiency cars. While some within the industry are attempting to achieve these goals by engineering more efficient internal combustion engines, others are incorporating hybrid or all-electric drive trains into their vehicle line-ups. To meet consumer expectations, however, the automobile industry must not only achieve a greener drive train, but must do so while maintaining reasonable levels of performance, range, reliability, safety and cost.

The most common approach to achieving a low emission, high efficiency car is through the use of a hybrid drive train in which an internal combustion engine (ICE) is combined with one or more electric motors. While hybrid vehicles provide improved gas mileage and lower vehicle emissions than a conventional ICE-based vehicle, due to their inclusion of an internal combustion engine they still emit harmful pollution, albeit at a reduced level compared to a conventional vehicle. Additionally, due to the inclusion of both an internal combustion engine and an electric motor(s) with its accompanying battery pack, the drive train of a hybrid vehicle is typically much more complex than that of either a conventional ICE-based vehicle or an all-electric vehicle, resulting in increased cost and weight. Accordingly, several vehicle manufacturers are designing vehicles that only utilize an electric motor, or multiple electric motors, thereby eliminating one source of pollution while significantly reducing drive train complexity.

In order to achieve the desired levels of performance and reliability in an electric vehicle, it is critical that the temperature of the traction motor remains within its specified operating range regardless of ambient conditions or how hard the vehicle is being driven. A variety of approaches have been used to try and adequately cool the motor in an electric car. For example, U.S. Pat. No. 6,191,511 discloses a motor that incorporates a closed cooling loop in which the coolant is pumped through the rotor shaft. A stationary axial tube mounted within the hollow rotor shaft injects the coolant while a series of blades within the rotor assembly pump the coolant back out of the rotor shaft and around the stator. Heat withdrawal is accomplished using fins integrated into the motor casing that allow cooling via ambient air flow.

U.S. Pat. No. 7,156,195 discloses a cooling system for use with the electric motor of a vehicle. The refrigerant used in the cooling system passes through an in-shaft passage provided in the output shaft of the motor as well as the reduction gear shaft. A refrigerant reservoir is formed in the lower portion of the gear case while an externally mounted cooler is used to cool the refrigerant down to the desired temperature.

U.S. Pat. No. 7,489,057 discloses a rotor assembly cooling system utilizing a hollow rotor shaft. The coolant feed tube that injects the coolant into the rotor shaft is rigidly coupled to the rotor shaft using one or more support members. As a result, the rotor and the injection tube rotate at the same rate. The coolant that is pumped through the injection tube flows against the inside surface of the rotor shaft, thereby extracting heat from the assembly.

While there are a variety of techniques that may be used to cool an electric vehicle's motor, these techniques typically only provide limited heat withdrawal. Accordingly, what is needed is an effective cooling system that may be used with the high power density, compact electric motors used in high performance electric vehicles. The present invention provides such a cooling system.

### SUMMARY OF THE INVENTION

The present invention provides a motor assembly with an integrated rotor cooling system, where the motor assembly is comprised of (i) a stator contained within a motor enclosure; (ii) a rotor shaft passing between the first end cap and the second end cap of the motor enclosure; and (iii) a rotor assembly mounted to the rotor shaft. The rotor assembly is comprised of a plurality of lamination discs assembled into a rotor stack, where each of the lamination discs include a plurality of slots co-aligned within the rotor stack and through which pass a plurality of conductive rotor bars, and a plurality of coolant apertures aligned within the rotor stack to form a plurality of coolant passageways that pass through the rotor stack between a first end surface and a second end surface of the stack.

The plurality of coolant passageways that pass through the rotor stack may be configured such that each coolant passageway (i) runs parallel to the rotor stack's cylindrical axis; (ii) is in a right-handed or a left-handed helical pattern centered about the rotor stack's cylindrical axis; (iii) is in a right-handed or a left-handed spiral pattern about the rotor stack's cylindrical axis; or (iv) pass directly through the rotor stack in a non-helical and a non-spiral pattern, where the distance between each of the coolant passageways and the rotor stack's cylindrical axis increases between the first and second end surfaces of the rotor stack.

In another aspect, each of the lamination discs may be stamped from metal and coated with an electrically insulating coating. The plurality of coolant apertures corresponding to each of the lamination discs may be formed by a stamping or a boring process.

In another aspect, the assembly further includes a coolant pump for injecting a coolant into the motor assembly and through the coolant passageways within the rotor stack. The coolant, which may be comprised of either oil or air, may be pressurized.

In another aspect, the assembly may further include first and second bearing assemblies, where the first bearing assembly is interposed between a first portion of the rotor shaft and the first end cap, and where the second bearing assembly is interposed between a second portion of the rotor shaft and the second end cap.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 provides a simplified cross-sectional view of the primary elements of a motor assembly;

FIG. 2 provides a perspective view of a rotor assembly, such as a rotor assembly for use in the motor of FIG. 1;

FIG. 3 provides a perspective view of some of the rotor assembly's primary components;

FIG. 4 provides an end view of a single lamination used in the formation of the lamination stack shown in FIG. 3;

FIG. 5 provides a cross-sectional view of a lamination stack using the single laminations shown in FIG. 4;

FIGS. 6A-6D provide end views of a lamination stack for each of the helical coolant passageways in a preferred embodiment of the invention;

FIGS. 7A-7D provide side views of the lamination stack of FIGS. 6A-6D for each of the coolant passageways;

FIGS. 8A-8D provide end views of a lamination stack for each of the spiral coolant passageways in an alternate preferred embodiment;

FIG. 9 provides an end view of a lamination stack for an alternate preferred embodiment of the invention;

FIG. 10 provides a cross-sectional view of the lamination stack shown in FIG. 9;

FIGS. 11A-11H illustrate coolant aperture placement for each of a plurality of lamination discs, with each passageway configured as a left-handed helix that rotates about the rotor assembly's cylindrical axis a quarter of a turn; and

FIG. 12 provides a cross-sectional view of the primary elements of a motor and integrated cooling system that may use the rotor cooling configuration of the invention.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, integers, steps, operations, elements, and/or components, but do not preclude the presence or addition of one or more other features, integers, steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps or calculations, these steps or calculations should not be limited by these terms, rather these terms are only used to distinguish one step or calculation from another. For example, a first calculation could be termed a second calculation, similarly, a first step could be termed a second step, similarly, a first component could be termed a second component, all without departing from the scope of this disclosure.

The motor and cooling systems described and illustrated herein are generally designed for use in a vehicle using an electric motor, e.g., an electric vehicle (EV), and may be used with a single speed transmission, a dual-speed transmission, or a multi-speed transmission. In the following text, the terms “electric vehicle” and “EV” may be used interchangeably and may refer to an all-electric vehicle, a plug-in hybrid vehicle, also referred to as a PHEV, or a hybrid vehicle, also referred to as a HEV, where a hybrid vehicle utilizes multiple sources of propulsion including an electric drive system.

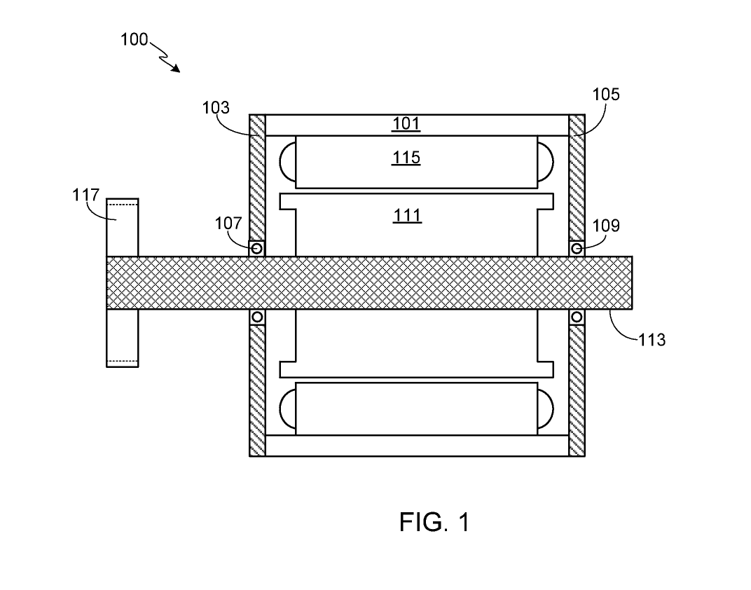

FIG. 1 provides a cross-sectional view of the primary elements of a conventional electric motor 100 that may utilize the rotor assembly of the invention. The housing of motor 100 is a multi-piece housing comprised of a cylindrical motor casing 101 that is mechanically coupled to front and rear end caps 103 and 105, respectively. The motor's core assembly, which is supported on either end by bearing assemblies 107 and 109, includes the rotor 111 and the rotor shaft 113. Also visible in this figure is stator 115.

At one end of rotor shaft 113 is a drive gear 117. Although not shown in this figure, drive gear 117 is contained within a gearbox (i.e., gear housing). The gearbox may be separate from motor 100; alternately, the gearbox or at least one wall of the gearbox may be integral with front motor housing member 103. An exemplary configuration utilizing an integrated motor/gearbox housing is shown in co-assigned U.S. patent application Ser. No. 14/503,683, filed 1 Oct. 2014, the disclosure of which is incorporated herein for any and all purposes.

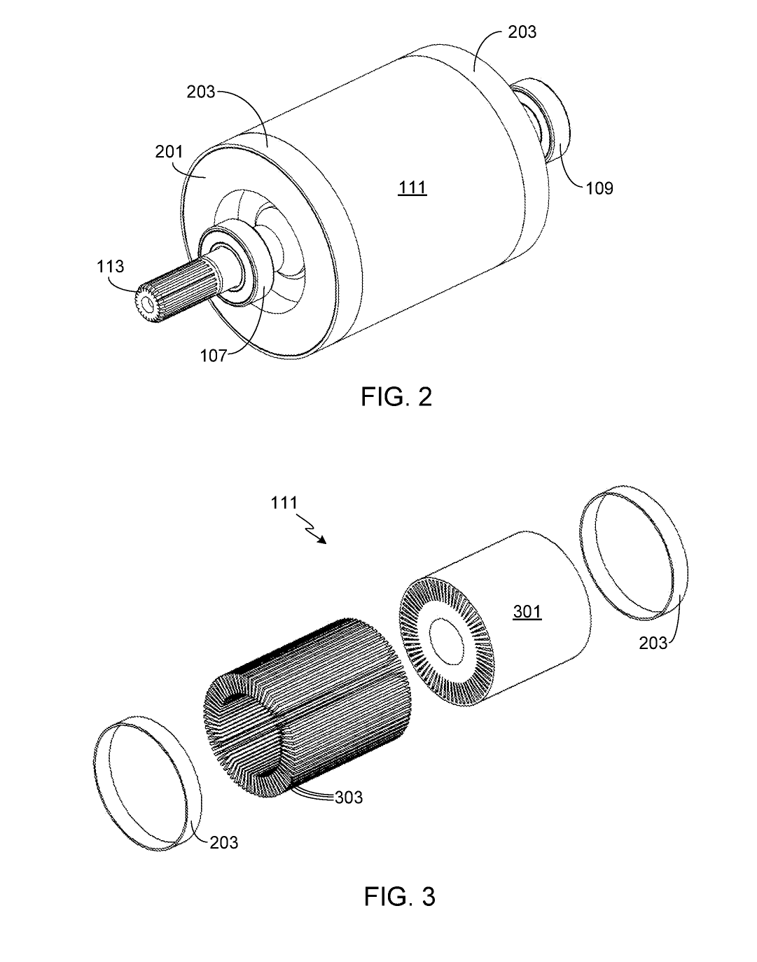

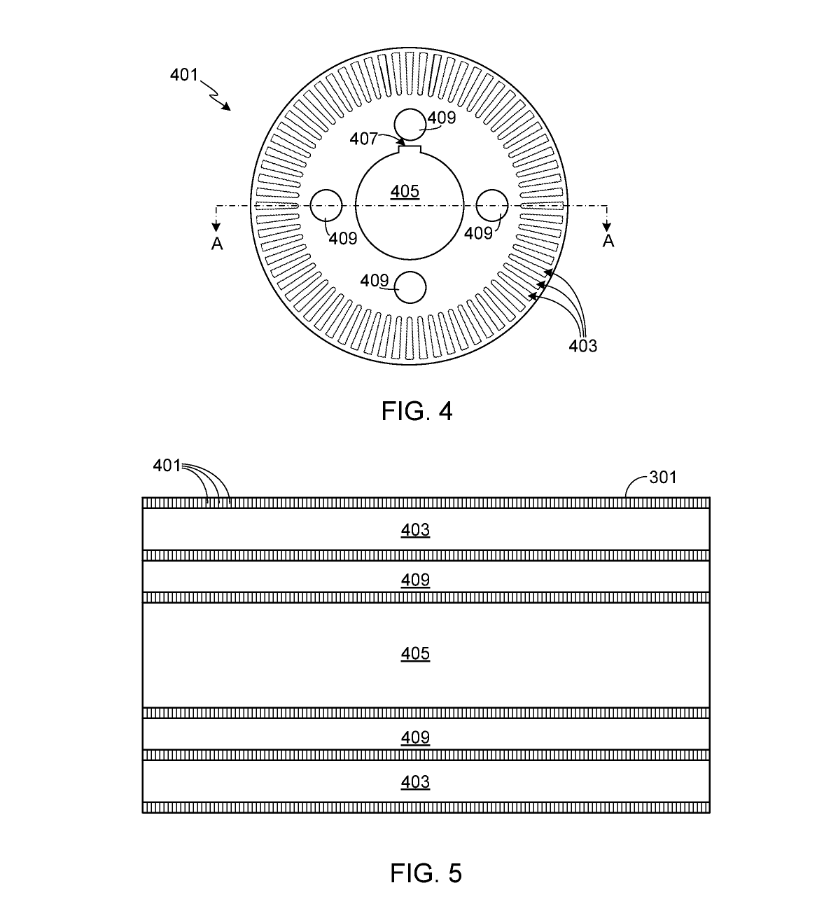

FIGS. 2 and 3 provide additional details regarding the rotor assembly of motor 100, FIG. 2 showing a perspective view of the rotor assembly and FIG. 3 showing a perspective view of some of the assembly's primary components. Rotor 111 is comprised of a stack 301 of lamination discs 401 (see FIG. 4). In a typical rotor assembly, stack 301 has a length in the range of 50 to 200 millimeters and an outer diameter in the range of 100 to 150 millimeters. Each disc 401, which is preferably comprised of steel with a thickness selected to be within the range of 0.18 to 0.40 millimeters, may be fabricated using a stamping process or other technique. Preferably discs 401 are coated, for example with an oxide, in order to electrically insulate the laminations from one another. Alternately, the metal discs comprising the stack may be electrically isolated from one another by the inclusion of an electrically insulating spacer disc located between adjacent metal discs.

Each disc 401 (or each disc 401 and each interposed spacer disc) includes a plurality of peripherally spaced openings or slots 403 through which conductive bars 303 are inserted or cast. Conductive bars 303 are typically fabricated from aluminum or copper. Slots 403, all of which have substantially the same shape and dimensions, have a shape that is complementary to the cross-sectional shape of conductive bars 303. At either end of the rotor assembly an end ring 201 is formed by mechanically and electrically joining together the ends of the conductive bars that extend beyond the stack. A containment ring 203 may be fit over end rings 201, thus helping to prevent end ring creep due to centripetal forces.

Preferably slots 403 have an approximately rectangular shape. Slots 403 may align such that they extend axially through stack 301, thus allowing each of the conductive bars 303 to be aligned in parallel with the rotor shaft. Alternately, slots 403 may be slightly skewed, thereby causing the conductive bars 303 within the rotor assembly to be oblique to the axis of the rotor shaft. It will be appreciated that the rotor assembly of the present invention is not limited to lamination discs that utilize a specific number of slots 403, nor is it limited to a specific shape for bars 303/slots 403, nor is it limited to a specific slot alignment configuration, rather the number, shape and alignment of the bars and slots in the figures are only meant to illustrate, not limit, the invention.

As shown in FIG. 4, the center portion 405 of each disc 401 is removed, for example during the disc stamping operation, thus providing an opening for rotor shaft 113. In at least one preferred configuration, open center portion 405 also includes a slot 407 that is sized to fit a key on rotor shaft 113, thereby providing means for locating and positioning the rotor shaft within the stack.

In accordance with the invention, each disc 401 of stack 301 includes at least one aperture 409, and preferably a plurality of apertures 409, that allow coolant to flow through the lamination stack, thereby helping to cool the rotor assembly. A plurality of coolant apertures 409, preferably evenly spaced about the stack's central axis, insure that rotor balance is maintained. Rotor balance is especially important for a high speed motor, such as those commonly used in an electric vehicle. Additionally, the use of a plurality of evenly spaced coolant apertures in stack 301 helps to provide more efficient, as well as more uniform, cooling of the rotor assembly. In the embodiment illustrated in FIG. 4 each lamination disc 401 includes four coolant apertures 409, although it should be understood that the invention may utilize a fewer number, or a greater number, of coolant apertures. Similarly, while the coolant apertures 409 shown in FIG. 4 are circularly-shaped, other aperture shapes may be used (e.g., rectangularly-shaped).

As each lamination disc 401 includes a set of coolant apertures 409, the relative locations of each of these apertures from disc to disc will determine the coolant passageways through the lamination stack. In general, the pattern of coolant flow passageways through the lamination stack is selected to achieve optimal heat transfer out of the rotor assembly. Factors that may influence the selection of a specific configuration of coolant apertures, and thus a particular coolant flow pattern, include the intended coolant, e.g., air versus a liquid coolant, as well as the intended application for the motor, e.g., a motor in a hybrid vehicle versus primary propulsion motor in an all-electric vehicle versus a non-vehicle motor.

FIG. 5 provides a cross-sectional view of stack 301 taken along plane A-A in FIG. 4 for an extremely simple coolant aperture configuration. As shown, in this configuration the coolant apertures 409 are aligned from disc-to-disc in order to achieve coolant passageways that run parallel with the cylindrical axis of stack 301, and thus parallel with the cylindrical axis of rotor shaft 113. The cylindrical axis of the lamination stack, and of the rotor assembly, may also be referred to herein as the longitudinal axis of rotation.

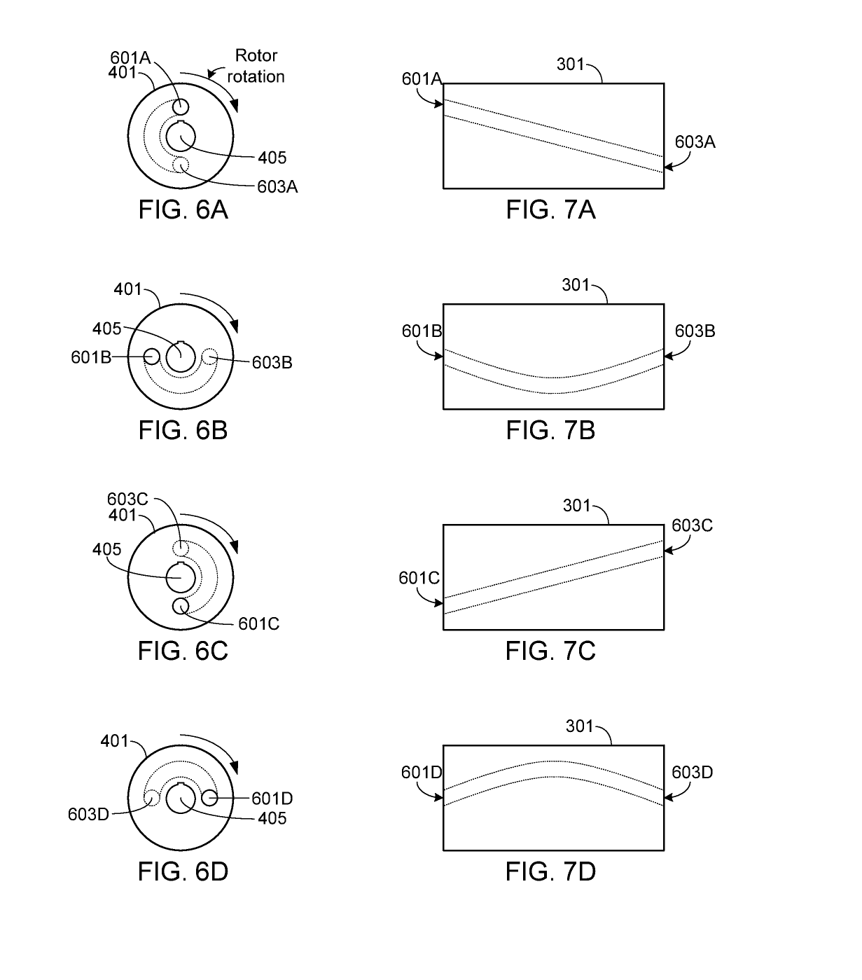

While the configuration shown in FIG. 5 allows coolant to pass through the lamination stack, the inventor has found that it is possible to create coolant aperture configurations that promote coolant flow through the rotor assembly and provide enhanced rotor cooling. For example by positioning the coolant apertures in a helix configuration (e.g., a left-handed helix), coolant flow is promoted as the rotor turns in a complementary direction (e.g., clockwise). This configuration is illustrated in FIGS. 6 and 7. In order to clearly illustrate the four coolant passageways, each figure is divided into four sub-figures, i.e., FIGS. 6A-6D and FIGS. 7A-7D, with each sub-figure corresponding to one of the four coolant passageways. For additional clarity, these figures do not include slots 403, and FIGS. 7A-7D do not include bore 405. In this illustrated configuration each helical coolant passageway rotates half a turn from the first coolant aperture of the lamination stack (i.e., apertures 601A-601D) to the last coolant aperture of the lamination stack (i.e., apertures 603A-603D). It should be understood that the invention is equally applicable to other helical patterns, e.g., coolant passageways that rotate more or less than half a turn, or even multiple turns within the stack. Additionally, the invention is not limited to configurations using four coolant passageways, rather the invention is equally applicable to configurations using fewer than, or more than, four coolant passageways.

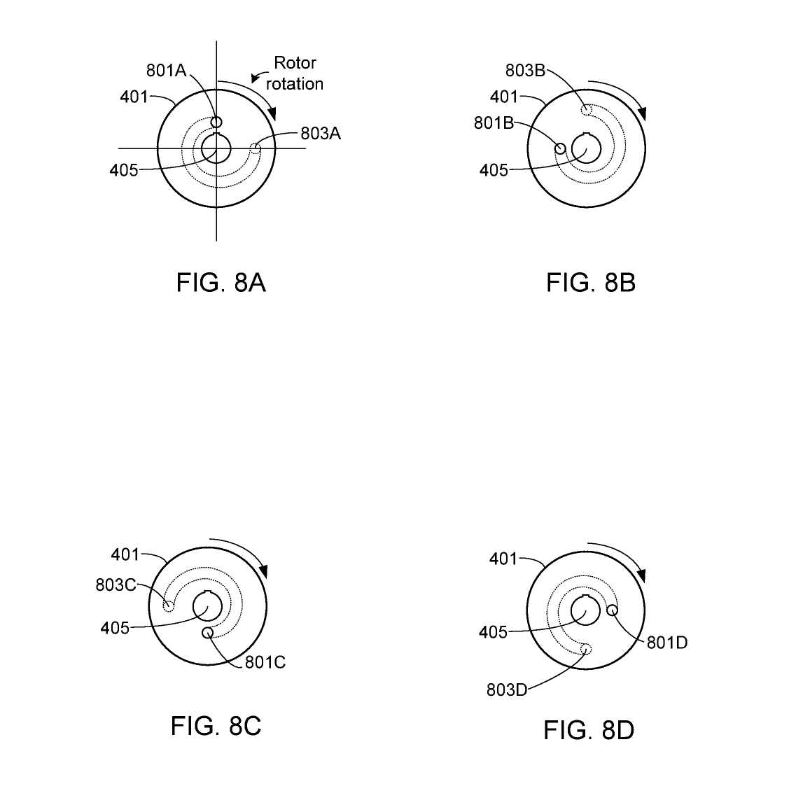

While helical coolant passageways provide efficient and balanced use of the space between the conductor slots and the central bore, it should be understood that other coolant passageway configurations may also be used with the invention. For example, each coolant passageway of a four passageway configuration is shown individually in FIGS. 8A-8D, where each coolant passageway uses a spiral configuration with an increasing radial distance from the central axis as the passageway extends through the stack. In this exemplary configuration, the coolant apertures are set-up in a left-handed spiral with each passageway rotating three-fourths of a full rotation as they pass through the stack. In these figures, apertures 801A-801D correspond to the first coolant aperture of the lamination stack for each passageway while apertures 803A-803D correspond to the last coolant aperture of the lamination stack for each passageway. It should be understood that the invention is equally applicable to other spiral patterns, e.g., spiral coolant passageways that rotate more or less than the exemplary configuration, and in which the radial distance between the coolant apertures and the cylindrical axis of the stack either increase or decrease, and in which a fewer number or greater number of coolant passageways are incorporated into the rotor assembly.

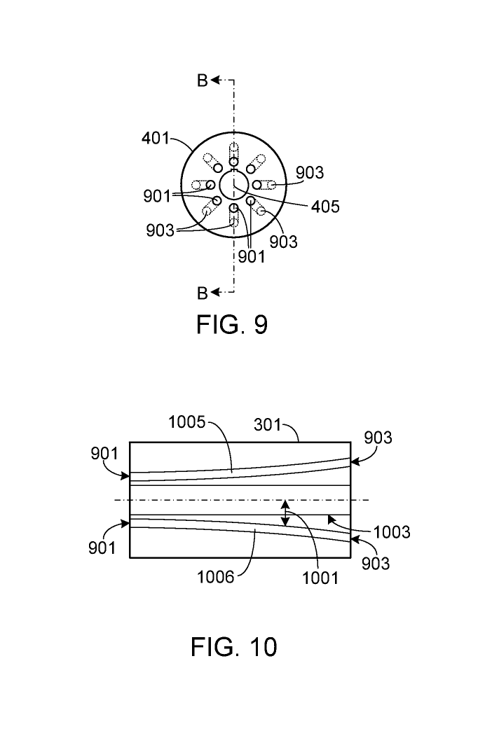

It will be appreciated that the invention may utilize coolant passageways other than those described above. For example and as illustrated in FIGS. 9 and 10, instead of the coolant passageways rotating about the rotor assembly's cylindrical axis, each coolant passageway extends directly through the lamination stack. However, rather than running parallel to the assembly's cylindrical axis as in the embodiment illustrated in FIG. 5, in the embodiment illustrated in FIGS. 9 and 10 the distance 1001 between each coolant passageway and the assembly's cylindrical axis 1003 is varied. As a result of this configuration, coolant flow is promoted as the rotor spins. In these figures, slots 403 are not shown, thus simplifying the figures. FIG. 9, which provides an end view of lamination stack 301, shows eight coolant passageways where coolant apertures 901 correspond to the first coolant aperture of the lamination stack for each passageway while apertures 903 correspond to the last coolant aperture of the lamination stack for each passageway. FIG. 10 provides a cross-sectional view, taken along plane B-B, and as such shows the curvature associated with two of the coolant passageways (e.g., passageways 1005/1006). As noted for the other embodiments, this embodiment may use a fewer number or a greater number of coolant passageways than the number illustrated in the figures.

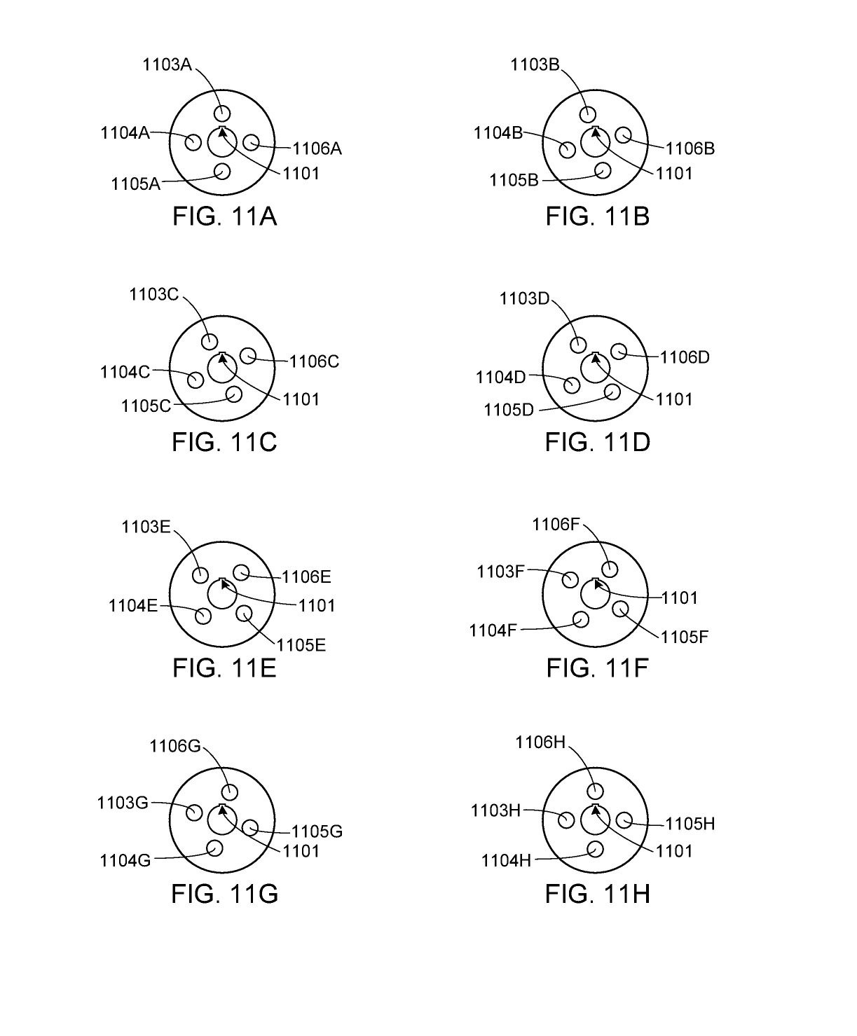

There are a variety of techniques that may be used to form the coolant passageways that pass through the lamination stack. For example, the passageways may be bored after the lamination stack is assembled. The inventor has found, however, that the preferred fabrication approach is to incorporate the requisite number of coolant apertures into each lamination disc, for example using the same stamping process used to fabricate the discs. Then during assembly of the lamination stack, the laminates are positioned to achieve the desired coolant passageways. While a typical lamination stack utilizes a large number of discs, the eight discs shown in FIGS. 11A-11H are sufficient to illustrate the concept.

The lamination discs shown in FIGS. 11A-11H are used to form a stack with four coolant passageways, with each passageway configured as a left-handed helix that rotates about the rotor assembly's cylindrical axis a quarter of a turn. In this exemplary embodiment the rotor slot 1101 is used to insure proper placement of the coolant apertures relative to one another. It should be understood that other techniques, such as dimples pressed into each disc, may be used to properly locate the coolant apertures from disc to disc. A fabrication mandrel may also be used during the stack assembly, where the mandrel has ‘fingers’ that align the coolant apertures. In the discs shown in FIGS. 11A-11H, apertures with the same number (e.g., 1103), but a different letter (e.g., A), are intended to be aligned to form a single coolant passageway. Accordingly one passageway is comprised of coolant apertures 1103A, 1103B, 1103C, 1103D, 1103E, 1103F, 1103G and 1103H. Similarly, a second passageway is comprised of coolant apertures 1104A, 1104B, 1104C, 1104D, 1104E, 1104F, 1104G and 1104H; a third passageway is comprised of coolant apertures 1105A, 1105B, 1105C, 1105D, 1105E, 1105F, 1105G and 1105H; and a fourth passageway is comprised of coolant apertures 1106A, 1106B, 1106C, 1106D, 1106E, 1106F, 1106G and 1106H.

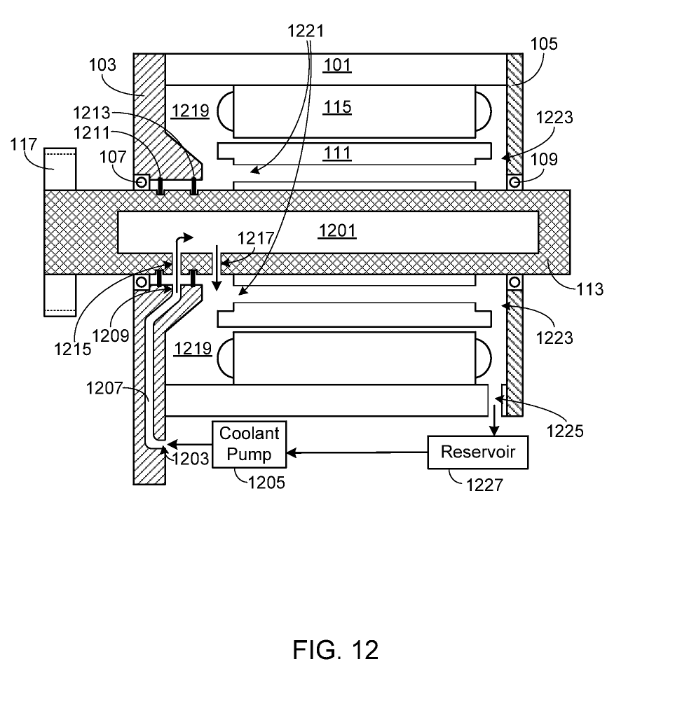

As previously described, either air or a liquid coolant can be forced through the coolant passageways formed within an electric motor's rotor assembly configured in accordance with the invention. Furthermore, any of a variety of cooling systems may be used to pump coolant through the coolant passageways. An exemplary cooling system is shown in FIG. 12, although it should be understood that other techniques may be used with the present invention.

FIG. 12 utilizes a similar motor design to that shown in FIG. 1. In this motor, however, the center portion 1201 of rotor shaft 113 is hollow. Integrated into one of the end caps of the motor assembly, and preferably integrated into front motor end cap 103 as shown, is a coolant intake 1203. Preferably the coolant is non-gaseous and has thermal and mechanical properties suitable for a liquid motor coolant, e.g., high heat capacity, high break-down temperature and a relatively low viscosity. Additionally, as the coolant flows between the rotor and stator as well as a small portion of the rotor shaft and the end cap, in the preferred embodiment the coolant is also a good lubricant and is electrically non-conductive. Accordingly, in at least one embodiment oil is used as the coolant.

In the exemplary cooling system illustrated in FIG. 12, the coolant passing into intake 1203 is pressurized via coolant pump 1205. In this embodiment coolant pump 1205 is an external pump, for example an electric pump, although other types of pumps may be used such as a mechanical pump powered by shaft 113. Coolant intake 1203 is coupled to a coolant passageway 1207 that is preferably incorporated within end cap 103 as shown. Passageway 1207 connects intake 1203 to output aperture 1209. Output aperture 1209 is within the bore of end cap 103, and thus is immediately adjacent to rotor shaft 113. The coolant is confined within the region between rotor shaft 113 and the bore of end cap 103 by a pair of seals 1211/1213. Seals 1211 and 1213 are not limited to a particular type of seal; rather they may be comprised of any of a variety of different seal types (e.g., rotary shaft seals) that form an adequate seal between shaft 113 and end cap 103 while allowing the shaft to freely rotate within the motor housing. In the preferred embodiment seal rings 1211/1213 fit within grooves formed within the bore of end cap 103 and the outer surface of rotor shaft 113 as shown. Seals 1211 and 1213 may be fabricated from any of a variety of materials (e.g., fluorosilicone, nitrile, silicone, polyacrylate, FEP, etc.).

Rotor shaft 113 includes one or more intake thru-holes 1215 immediately adjacent to the region defined by rotor shaft 113, the bore of end cap 103, and seals 1211/1213. Intake thru-hole(s) 1215 allows coolant passing through coolant passageway 1207 to flow into the central, hollow region 1201 of rotor shaft 113. The coolant within region 115 is then forced out of shaft 113 through multiple thru-holes 1217, this coolant flowing throughout region 1219 of the motor enclosure. The coolant within the motor enclosure then flows through the coolant passageways 1221 integrated into the rotor stack in accordance with the invention, and as described above. After passing through the rotor stack coolant passageways 1221, the coolant flows into area 1223 of the motor enclosure prior to passing through one or more output apertures 1225 before being collected into coolant reservoir 1227. Reservoir 1227 is coupled to coolant pump 1205. The heat absorbed by the coolant can be transferred to the ambient environment or to another thermal system (e.g., refrigeration system) using any of a variety of well-known techniques.

The embodiment described above provides efficient heat removal via multiple thermal passageways. Specifically, circulating the coolant throughout the system allows heat to be removed via direct transfer between the coolant and the rotor shaft (e.g., via region 1201 within shaft 113), between the coolant and rotor 111 via coolant passageways 1221, and between the coolant and the stator 115. This approach also effectively cools the motor bearings.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A motor assembly with an integrated rotor cooling system, comprising:
a stator contained within a motor enclosure;
a rotor shaft, wherein said rotor shaft passes between a first end cap and a second end cap of said motor enclosure; and
a rotor assembly mounted to said rotor shaft, said rotor assembly comprising:
a plurality of lamination discs, wherein each of said plurality of lamination discs is comprised of a plurality of slots, wherein each of said plurality of lamination discs is comprised of a plurality of coolant apertures, wherein said plurality of lamination discs is assembled into a rotor stack, wherein said plurality of slots of each of said plurality of lamination discs are co-aligned within said rotor stack, and wherein said plurality of coolant apertures corresponding to each of said plurality of lamination discs are aligned within said rotor stack to form a plurality of coolant passageways that pass through said rotor stack between a first end surface of said rotor stack and a second end surface of said rotor stack; and
a plurality of conductive rotor bars passing through said plurality of slots of said plurality of lamination discs comprising said rotor stack.

2. The motor assembly of claim 1, wherein each of said plurality of coolant passageways passing through said rotor stack runs parallel to a cylindrical axis of said rotor stack.

3. The motor assembly of claim 1, wherein each of said plurality of coolant passageways passing through said rotor stack is configured in a helical pattern centered about a cylindrical axis of said rotor stack.

4. The motor assembly of claim 3, wherein each of said plurality of coolant passageways passing through said rotor stack is configured in a right-handed helical pattern.

5. The motor assembly of claim 3, wherein each of said plurality of coolant passageways passing through said rotor stack is configured in a left-handed helical pattern.

6. The motor assembly of claim 1, wherein each of said plurality of coolant passageways passing through said rotor stack is configured in a spiral pattern about a cylindrical axis of said rotor stack.

7. The motor assembly of claim 6, wherein each of said plurality of coolant passageways passing through said rotor stack is configured in a right-handed spiral pattern.

8. The motor assembly of claim 6, wherein each of said plurality of coolant passageways passing through said rotor stack is configured in a left-handed spiral pattern.

9. The motor assembly of claim 1, wherein each of said plurality of coolant passageways passes directly through said rotor stack in a non-helical and non-spiral pattern, and wherein a distance between each of said plurality of coolant passageways and said cylindrical axis of said rotor stack increases between said first end surface of said rotor stack and said second end surface of said rotor stack.

10. The motor assembly of claim 1, wherein each of said lamination discs is stamped from a metal and coated with an electrically insulating coating.

11. The motor assembly of claim 10, wherein said plurality of coolant apertures corresponding to each lamination disc of said plurality of lamination discs is formed by a stamping process.

12. The motor assembly of claim 10, wherein said plurality of coolant apertures corresponding to each lamination disc of said plurality of lamination discs is formed by a boring process.

13. The motor assembly of claim 1, further comprising a coolant pump for injecting a coolant into said motor assembly and through said plurality of coolant passageways within said rotor stack.

14. The motor assembly of claim 13, wherein said coolant injected into said motor assembly is pressurized.

15. The motor assembly of claim 13, wherein said coolant is comprised of an oil.

16. The motor assembly of claim 13, wherein said coolant is comprised of air.

17. The motor assembly of claim 1, further comprising a first bearing assembly and a second bearing assembly, wherein said first bearing assembly is interposed between a first portion of said rotor shaft and said first end cap, and wherein said second bearing assembly is interposed between a second portion of said rotor shaft and said second end cap.
